(19) United States
(12) Patent Application Publication
(10) Pub. No.: US 2016/0029541 A1
(43) Pub. Date: Feb. 4, 2016

(54) Elastic Rubber Suspension for an Agricultural Implement

(71) Applicant: Daniel Richard Martindale, Spencerville, IN (US)

(72) Inventor: Daniel Richard Martindale, Spencerville, IN (US)

(21) Appl. No.: 14/445,154

(22) Filed: Jul. 29, 2014

(51) Int. Cl. A01B 61/04

(52) U.S. Cl. CPC A01B 61/046

(57) ABSTRACT

A suspension assembly for an agricultural implement having a carrier frame, an implement support frame pivotally connected to the carrier frame, and a rubber torsion spring having a drive shaft disposed coaxially within a square tubular housing, with an elastic rubber element captured within the housing and the shaft embedded in and adhered to the elastic rubber element. The torsion spring is connected to the implement support frame. An externally threaded screw has an internally threaded member engaged therewith, the screw being connected to the carrier frame. An adjusting arm has a first portion in driving engagement with the drive element, and has a second portion connected to the threaded member. Displacing the threaded member along the screw provides selectable spring force that adjustably biases the implement support frame away from the carrier frame such that an implement connected to the support frame is pressed against the soil with a selected force.

### BACKGROUND OF THE INVENTION

1. Field of the Invention

The present invention relates generally to agricultural machines and, more particularly, to a suspension assembly for soil tillage implements.

2. Description of the Related At

The related art includes various machines for tilling and preparing soil for planting, involving a generally horizontally disposed framework carried and supported above the surface of the ground by axles mounted to the framework and equipped with wheels, tracks or some other rolling element for a similar purpose. The framework is usually towed as a trailer behind tractor. The framework includes one or more implements attached thereto and disposed therebelow so that the working edges of the implements contact and penetrate the soil as the framework is pulled across the soil.

One type of soil tillage implement that is particularly useful involves a plurality of generally triangular tines radiating from an implement axle and spaced along the length of the axle. The implement axle is oriented generally horizontally and is pulled in a direction of travel generally perpendicular to its axis. It can be advantageous for the purpose of loosening the soil to provide for adjustment of the implement such that its axis is offset by a small angle, from about one to about three degrees, relative to true perpendicular to the direction of travel. Examples of the types of implements and trailer frameworks discussed above can be found in U.S. Pat. Nos. 6,854,525 and 8,327,947 issued to Martindale, and in U.S. Patent Publication No. US 2011/0220373 A1, each of which is hereby incorporated by reference.

It would be desirable to provide an improved suspension assembly for supporting soil tillage implements relative to a towed tillage machine frame that absorbs shocks and adjusts automatically to uneven ground, and that provides fir adjustable and selectable pressure of the tillage implement against the soil surface. This and other desirable advantages are obtained by the present invention.

### SUMMARY OF THE INVENTION

In one form thereof, the present invention is directed to a suspension assembly for an agricultural implement, including a carrier frame, an implement support frame pivotally connected to the carrier frame, and a rubber torsion spring having a drive element and a mounting element. The mounting element is connected to the implement support frame. A threaded screw having a threaded member engaged therewith is connected to the carrier frame. An adjusting arm has a first portion in driving engagement with the drive element, and has a second portion connected to the threaded member. Displacing the threaded member along the screw provides selectable spring force that biases the implement support frame away from the carrier frame.

In another form thereof, the present invention is directed to a suspension assembly for an agricultural implement, including a carrier frame, an implement support frame mounted to the carrier frame for movement relative thereto, and an elastic rubber torsion spring having a drive element and a mounting element. The mounting element is connected to the implement support frame. An adjustable linkage is connected to the carrier frame and to the drive element. Adjustment of the adjustable linkage provides selectable spring force that biases the implement support frame away from the carrier frame.

In yet another form thereof, the present invention is directed to a suspension assembly for an agricultural implement having a torsion spring including a drive element and elastic rubber element. The drive element is adapted to rotate about an axis and transfer a rotational force to the rubber element. An agricultural implement is mounted to the drive element or the elastic rubber element, such that movement of the implement causes the drive element to rotate about the axis relative to the rubber element and elastically flex the rubber element.

### BRIEF DESCRIPTION OF THE DRAWINGS

The above mentioned and other features of this invention, and the manner of attaining them, will become more apparent and the invention itself will be better understood by reference to the following description of embodiments of the invention taken in conjunction with the accompanying drawings, wherein:

FIG. 1 is a perspective view, partially cut away, of a suspension assembly for an agricultural implement.

FIG. 2 is a front view of the suspension assembly and implement of FIG. 1.

FIG. 3 is a transverse sectional view of the suspension assembly of FIG. 2 taken in section plane 3-3 and viewed in the direction of the arrows.

FIG. 4 is an exploded perspective view of the suspension assembly and implement of FIG. 1.

FIG. 5 is a perspective view, partially cut away, of an elastomeric torsion spring of the suspension assembly and implement of FIG. 1.

Corresponding reference characters indicate corresponding parts throughout the several views. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION OF THE PREFERRED EMBODIMENTS

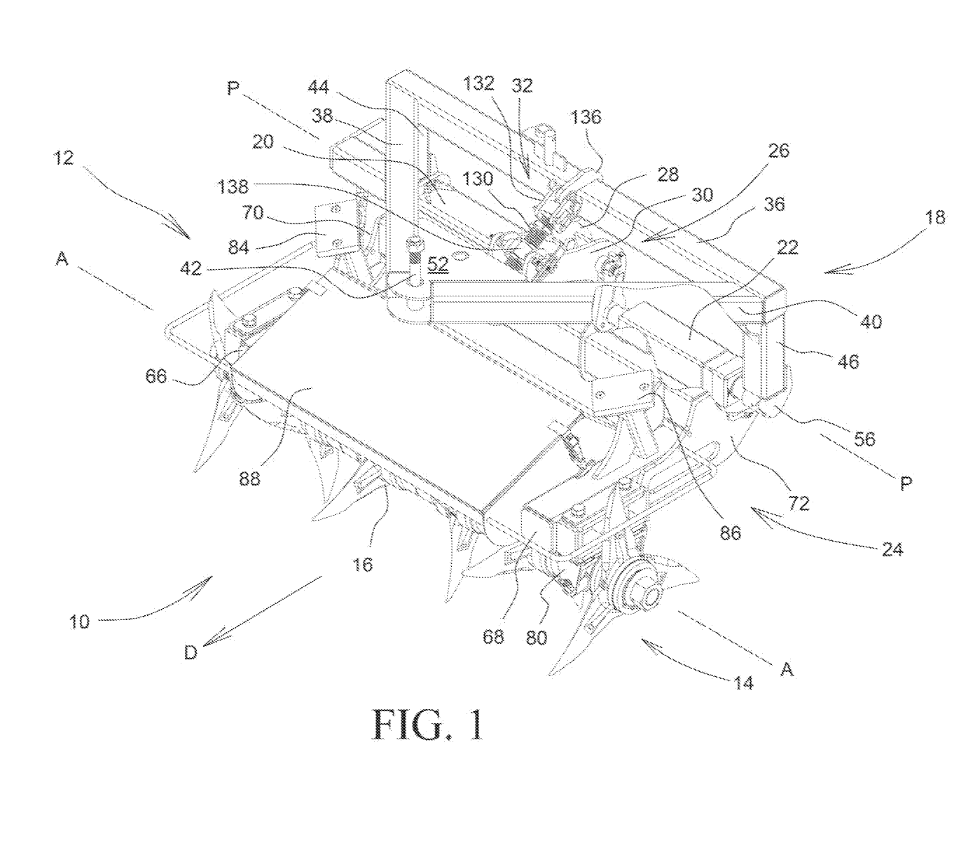

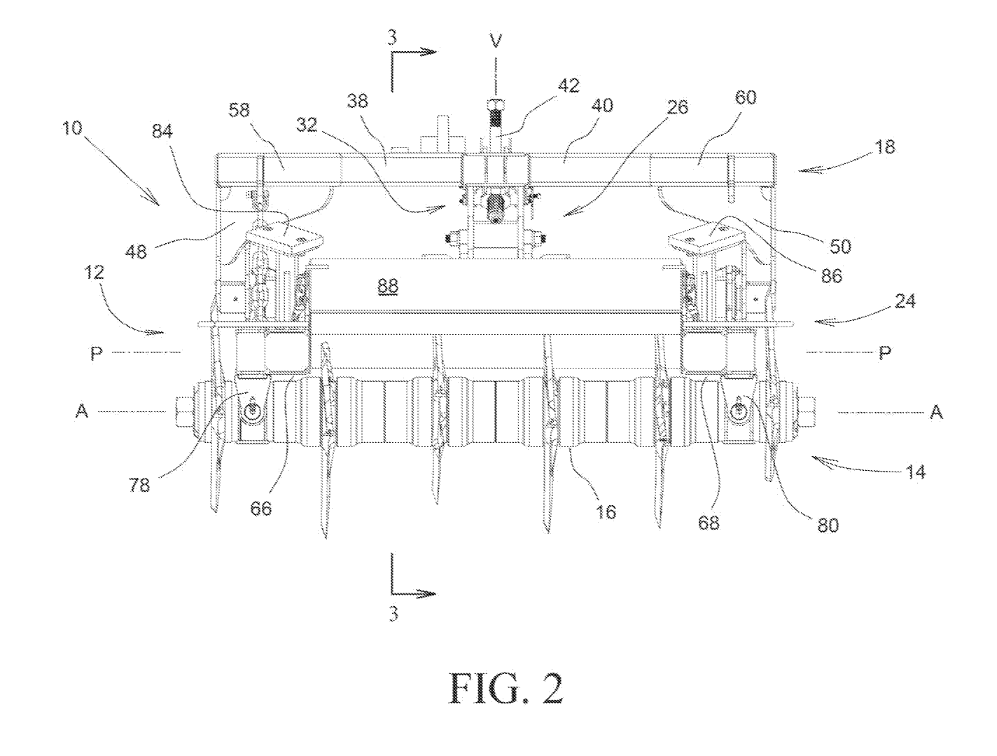

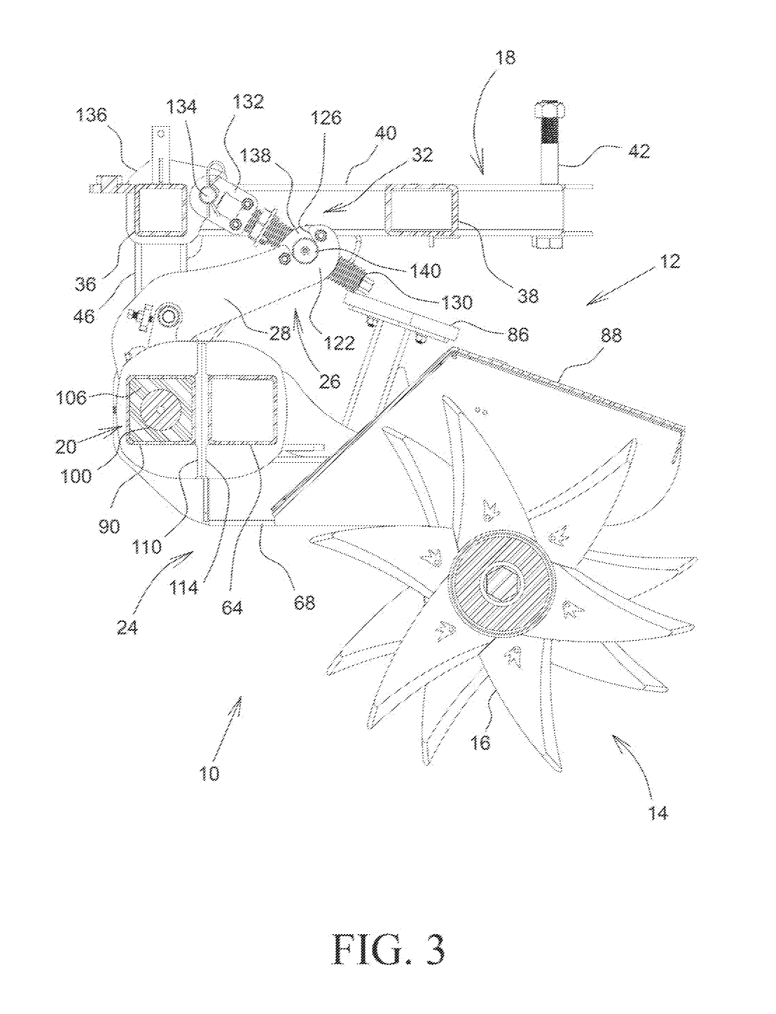

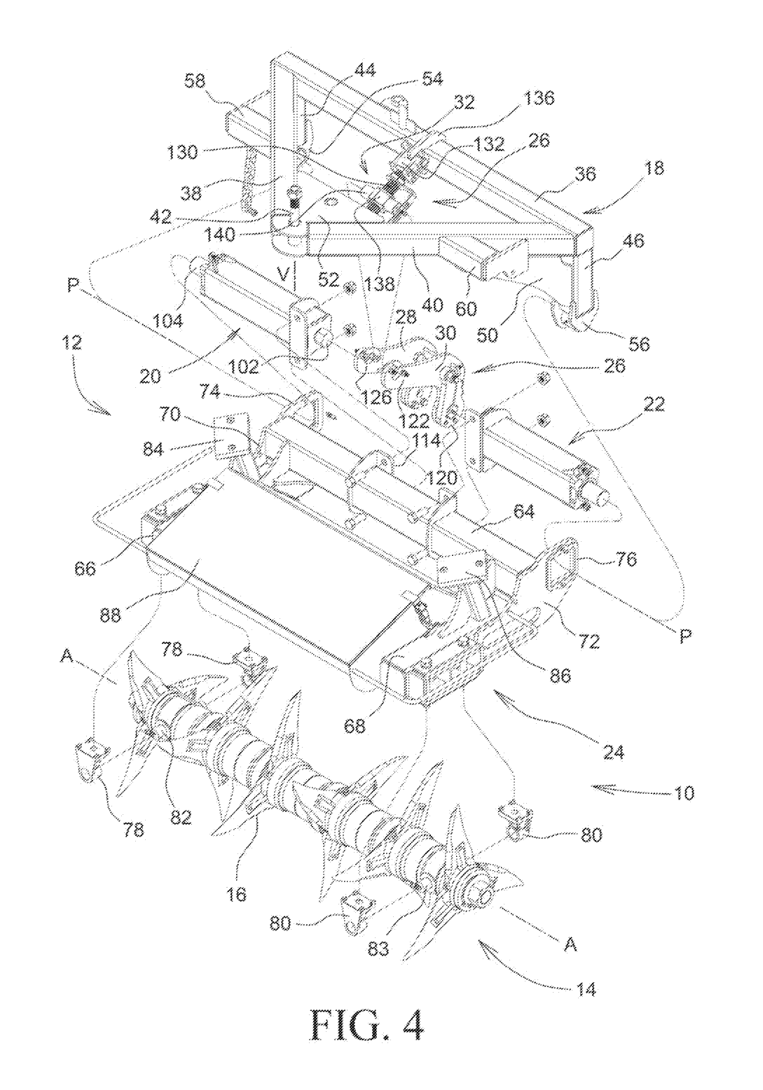

Referring to FIGS. 1-5, there is illustrated an example of an agricultural module 10 including a suspension assembly 12 that carries and supports a soil working implement 14, most preferably a tine assembly 16. A disc assembly or other known soil working implement can be substituted for tine assembly 16.

Suspension assembly 12 includes as principle components a carrier frame 18, a pair of torsion springs 20, 22, and an implement support frame 24. Torsion springs 20, 22 are rigidly affixed to support frame 24, the latter being pivotally connected to carrier frame 18. An adjustable linkage 26, including a pair of adjusting arms 28, 30 and an adjustment assembly 32, connects the torsion springs 20, 22 to the carrier frame 18. Support frame 24 carries and supports implement 14, for example tine assembly 16, for rotation about an axis A oriented substantially parallel to the surface of the soil.

Carrier frame 18 is a weldment including a main cross member 36 and yoke members 38 and 40 welded thereto to form a triangular frame oriented in a substantially horizontal plane. A pivot bolt 42 located proximate the apex of triangular carrier frame 18 permits attachment of module 10 to a known wheeled, agricultural machine frame (not shown) for pivotal positioning about vertical axis V. Additional apparatus, not shown, associated with the agricultural machine frame permits carrier frame 18 to be held at a selected angular displacement relative to the machine frame such that the axis A of implement 14 is offset by about one degree to about 3 degrees from perpendicular to the direction of travel (indicated by arrow D).

At opposite ends of main cross member 36, respective vertical frame members 44, 46 are welded thereto and extend downwardly therefrom. Braces 48, 50 are welded to frame members 44 and 38, and 46 and 40, respectively, to enhance rigidity of carrier frame 18. A brace 52 is welded to yoke members 38 and 40 proximate the apex of triangular carrier frame 18 to provide additional rigidity. Pivot bearing supports 54, 56 are welded to the lower ends of vertical frame members 44, 46, respectively, and are aligned to receive shafts (described further below) therein for rotation about a substantially horizontal axis P generally parallel to main cross member 36. Stops 58, 60 are welded to yoke members 38 and 40, respectively, and extend substantially horizontally outwardly therefrom. Stops 58, 60 engage a respective pair of stops on implement support frame 24, described further below.

Implement support frame 24 is a weldment including a main frame member 64 oriented substantially parallel to axis P, and support arms 66, 68 extending substantially perpendicularly and generally horizontally from opposite ends of main frame member 64. Braces 70, 72 are welded to main frame member 64 and to support arms 66 and 68, respectively, to provide increased rigidity of support frame 24. Braces 70, 72 also support bearing apertures 74, 76, respectively, aligned to receive shafts (described further below) therein for rotation about axis P. Bearing apertures 74, 76 are spaced to fit between and align axially with pivot bearing supports 54, 56 along axis P. Support arms 66, 68 receive and support mounting brackets 78, 80, respectively. Mounting brackets 78, 80 receive and support trunnions 82, 83, respectively, of tine implement assembly 16 which is arranged and configured for rotation about axis A.

Stops 84, 86 are welded to support arms 66, 68, respectively, and are located to engage stops 58, 60, respectively, to limit the pivotal excursion of support frame 24 toward carrier frame 18. An expanded perforated metal guard 88 is disposed between support arms 66 and 68 and above implement 14 for operator safety and to impede soil from being thrown upwardly by tine assembly 16 into the mechanisms of suspension assembly 12.

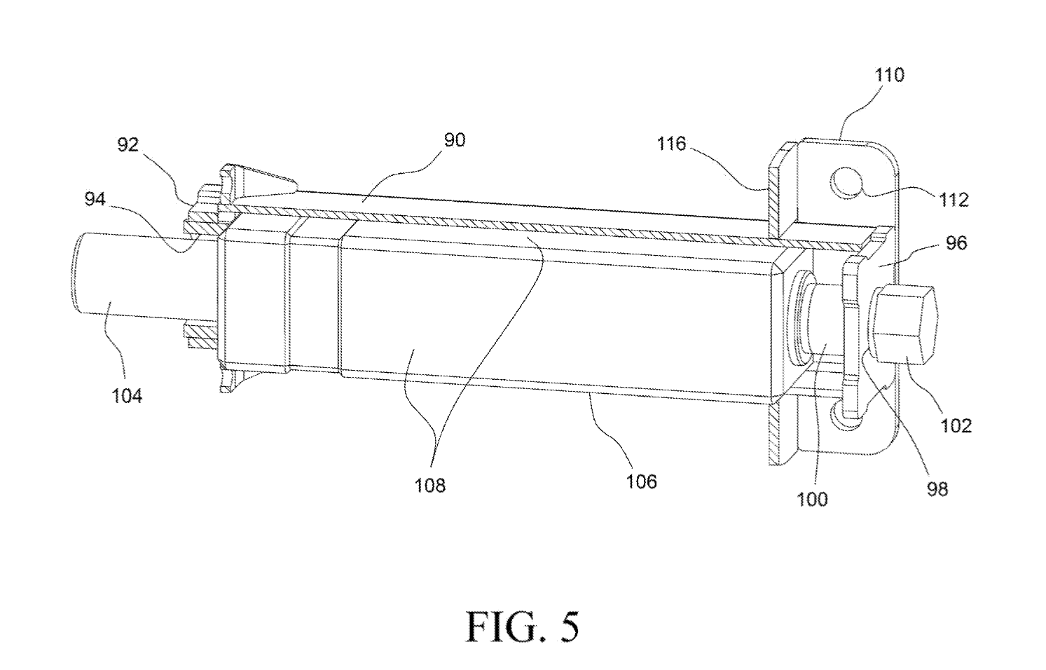

With particular reference to FIG. 5, torsion spring 20 is shown, partially cut away. Torsion spring 22 is substantially similar in configuration to spring 20. Spring 20 includes as its principle components an elongate tubular steel housing 90 of square cross-section. Housing 90 is partially closed at one end by a first end plate 92 having a round central aperture 94 therethrough and is partially closed at the other end by a second end plate 96 having a round central aperture 98 therethrough. End plates 92 and 96 are welded to housing 90. Extending axially through housing 90 and apertures 94 and 98 is a steel shaft 100 having a hexagonal drive end 102 disposed outwardly of second end plate 96 and a bearing end 104 disposed outwardly of first end plate 92. Both apertures 94 and 98 are sized relative to shall 100 to provide clearance for rotational displacement of shaft 100 therein. Surrounding shaft 100 and securely adhered thereto is an elongate rectangular spring block 106 comprising an elastomeric material such as rubber or the like. Spring block 100 substantially fills the cross-section of housing 90.

The four sides 108 of spring block 106 engage the inner wall of square tubular housing 90 such that the periphery of spring block 106 is restrained from being displaced rotationally relative to housing 90 as torque is applied to shaft 100 via hexagonal drive end 102. Because shall 100 is securely adhered to the elastomeric material of spring block 106, torque applied to shaft 100 relative to housing 90 induces shear forces, strain and elastic deformation within spring block 106. Shaft 100 is thereby able to be displaced rotationally by such torque, relative to housing 90, with the torsional spring force generated in reaction thereto being in a non-linear proportional relationship to the angle of rotation of the shaft 100 relative to the housing 90. The more the shaft is rotated relative to housing 90, the greater the counter spring force. This effect is bidirectional in that spring force will be induced by rotating shall 100 in either direction relative to housing 90.

Proximate second end plate 96, a bracket 110 is welded substantially parallel to the side of housing 90, and included holes 112 therethrough for receiving bolts to mount and affix torsion spring 20 rigidly to a corresponding bracket 114 that is welded to main frame member 64 of implement support frame 24. Similar brackets are provided for mounting and affixing torsion spring 22 to main frame member 64. A brace 116 oriented perpendicular to bracket 110 is welded thereto and to housing 90 to reinforce bracket 110.

Spring 20 is mounted substantially parallel to main frame member 64 such that the bearing end 104 of shaft 100 that protrudes from end plate 92 extends through and engages bearing aperture 74 of brace 70. Bearing aperture 74 locates and constrains bearing shaft end 104 laterally relative to implement support frame 24, while permitting relative rotation of shaft 100 with respect to support frame 24 as torque is applied to hexagonal drive end 102. Spring 22 is mounted similarly with respect to bearing aperture 76. That portion of protruding bearing end 104 of shaft 100 that extends through and beyond bearing aperture 74 is received in pivot hearing support 54 of carrier frame 18. The bearing end of the shaft of spring 22 is similarly received in pivot bearing support 56. Together, the shafts 100 of springs 22, 24 connect and support implement support frame 24 to and in pivotal relationship with carrier frame 18 for pivoting about axis P.

Adjusting arms 28, 30 comprise a pair of substantially similar, generally L-shaped members that are connected together as an assembly that moves together as a unit. Adjusting arms 28 and 30 are mirror images of each other, so the following descriptions of the features and arrangements of either arm apply as well to the other arm with regard to their respective interactions with torsion springs 20, 22. Adjusting arms 28, 30 can be conceived as a unitary, symmetrical structure, each of the arms including first legs 120 and second legs 122. First legs 120 define hexagonally shaped drive apertures 124 in which hex drive end 102 of torsion springs 20, 22 is received in driving engagement for transmission of torque. Second legs 122 define a yoke 126 for engaging adjustment assembly 32, described further below.

Adjustment assembly 32 includes a spirally threaded screw rod 130 connected at one end to a mounting yoke 132 for free rotation relative thereto, but restrained against axial displacement relative thereto. A pivot pin 134 is received through aligned holes in yoke 132 and through a hole defined by a mounting bracket 136 that is affixed, preferably by welding, to main cross member 36 of carrier frame 18. The holes through yoke 132 and bracket 136 are aligned with a generally horizontal axis substantially parallel to axis P such that yoke 132 and screw rod 130 can pivot in a vertical plane about the horizontal axis of pivot pin 134. Intermediate the ends of spirally threaded screw rod 130, an internally threaded trunnion member 138 is threadedly received thereabout in threaded engagement therewith. By rotating screw rod 130 about the longitudinal axis thereof relative to mounting yoke 132 and trunnion member 138, the threaded engagement between screw rod 130 and trunnion member 138 causes trunnion member 138 to be displaced along the axis of screw rod 130, thereby adjusting the distance of trunnion member 138 from main cross member 36. A pair of pins 140 extends transversely from trunnion member 138 and is received in yoke 126 of adjusting arms 28, 30.

By adjusting the location of trunnion member 138 along screw rod 130, trunnion pins 140 in engagement with yoke 126 displace the second leg 122 of adjusting arms 28, 30 toward or away from main cross member 36 depending on the direction that screw rod 130 is rotated relative to trunnion member 138. Displacement of second leg 122 away from main cross member 36 causes a moment about axis P. Torque is transferred from first leg 120 via hexagonal drive aperture 124 to hex drive end 102 of torsion springs 20, 22, and thereby to shaft 100 within. Consequently, shaft 100 is caused to rotate relative to housing 90, and hence relative to support frame 24, thereby deforming rubber spring block 106 and generating a reacting spring three in torsion springs 20, 22 that biases support frame 24 away from carrier frame 18 about pivot axis P. The spring bias is transferred from support frame 24 to implement 14, thereby causing the tines of tine assembly 16 to be pressed into the surface of the soil with greater or lesser force depending on the adjusted configuration of adjustment assembly 32.

Alternatively, a hydraulic cylinder, electrically powered linear actuator, linear position adjuster or other linear force generator could be substituted tor threaded rod 130 between yoke 132 and trunnion member 138 to effect selected displacement thereof relative to carrier frame 18 and to adjust the spring force of torsion springs 20, 22.

While this invention has been described as having an exemplary design, the present invention may be further modified within the spirit and scope of this disclosure. This application is therefore intended to cover any variations, uses, or adaptations of the invention using its general principles.

What is claimed is:

1. A suspension assembly for an agricultural implement, comprising:
a carrier frame;
an implement support frame pivotally connected to said carrier frame;
a rubber torsion spring having a drive element and a mounting element, said mounting element connected to said implement support frame;
a threaded screw having a threaded member engaged therewith, said screw connected to said carrier frame; and
an adjusting arm having a first portion in driving engagement with said drive element, and having a second portion connected to said threaded member;
whereby displacing said threaded member along said screw provides selectable spring three that biases said implement support frame away from said carrier frame.

2. The suspension assembly of claim 1, wherein:
said drive element includes a shaft supported for rotational displacement relative to said mounting element.

3. The suspension assembly of claim 2, including:
an elastic rubber element adhered to said shaft.

4. The suspension assembly of claim 3, wherein:
said shaft is embedded in said elastic rubber element.

5. The suspension assembly of claim 4, wherein:
said elastic rubber element has a periphery constrained against rotational displacement relative to said mounting element.

6. The suspension assembly of claim 5, wherein:
said threaded member includes a trunnion.

7. The suspension assembly of claim 6, wherein:
said second portion of said adjusting arm includes a yoke engaging said trunnion.

8. The suspension assembly of claim 1, wherein:
said threaded member includes a trunnion.

9. The suspension assembly of claim 8, wherein:
said second portion of said adjusting arm includes a yoke engaging said trunnion.

10. The suspension assembly of claim 9, wherein:
said drive element includes a shaft supported for rotational displacement relative to said mounting element.

11. The suspension assembly of claim 10, including:
an elastic rubber element adhered to said shaft.

12. A suspension assembly for an agricultural implement, comprising:
a carrier frame;
an implement support frame mounted to said carrier frame for movement relative thereto;
an elastic rubber torsion spring having a drive element and a mounting element, said mounting element connected to said implement support frame; and
an adjustable linkage connected to said carrier frame and to said drive element;
whereby adjustment of said adjustable linkage provides selectable spring force that biases said implement support frame away from said carrier frame.

13. The suspension assembly of claim 12, wherein:
said drive element includes a shaft supported for rotational displacement relative to said mounting element.

14. The suspension assembly of claim 13, wherein:
said torsion spring includes an elastic rubber element having a periphery constrained. against rotational displacement relative to said mounting element.

15. The suspension assembly of claim 14, wherein:
said shaft is embedded in said elastic rubber element.

16. The suspension assembly of claim 15, wherein:
said mounting element includes a tubular housing.

17. A suspension assembly for an agricultural implement, comprising:
a torsion spring including a drive element and elastic rubber element, said drive element adapted to rotate about an axis and transfer a rotational force to said rubber element; and,
an agricultural implement mounted to one of said drive element or elastic rubber element, whereby movement of said implement causes said drive element rotate about said axis relative to said rubber element and elastically flex said rubber element.

18. The suspension assembly of claim 17 wherein said drive element is adhered to said elastic rubber element.

19. The suspension assembly of claim 18 wherein said drive element is captured within said elastic rubber element.

20. The suspension assembly of claim 19 wherein said drive element includes a shaft.
